(19) United States
(12) Patent Application Publication
(10) Pub. No.: US 2013/0308325 A1
(43) Pub. Date: Nov. 21, 2013

(54) MOUNTING ASSEMBLY FOR HANGING FIXTURE AND RELATED INSTALLATION METHOD

(71) Applicant: Orion Energy Systems, Inc., Manitowoc, WI (US)

(72) Inventors: Neal R. Verfuerth, Manitowoc, WI (US); Matthew S. Tlachac, Manitowoc, WI (US)

(21) Appl. No.: 13/897,060

(22) Filed: May 17, 2013

Related U.S. Application Data
(60) Provisional application No. 61/648,952, filed on May 18, 2012.

(51) Int. Cl. F21V 21/30

(52) U.S. Cl. CPC F21V 21/30
USPC 362/371; 29/428; 29/525.01

(57) ABSTRACT

A mounting assembly for attaching a lighting fixture to an overhead structure. The mounting assembly includes at least a first member and a second member. The first member is configured to be coupled to the overhead structure and includes a base with an opening provided therein. The second member is configured to be coupled to the fixture and includes a body and an catch extending from the body. The catch is configured to engage the opening to pivotally connect the second member to the first member, such that the base is substantially parallel to the body.

### CROSS-REFERENCE TO RELATED PATENT APPLICATIONS

This application claims the benefit of and priority to U.S. Provisional Patent Application No. 61/648,952, filed on May 18, 2012. The foregoing U.S. provisional patent application is incorporated by reference herein in its entirety.

### BACKGROUND

The present application relates generally to the field of hanging or suspended lighting fixtures for use in buildings and other applications.

Lighting fixtures are generally used in buildings and other types of structures to provide light sources, such as, for example, to illuminate working areas within the building or structure. For example, a relatively large commercial building may include numerous overhead lighting fixtures suspended from a ceiling structure of the building to provide the amount of light that is necessary to illuminate the vast working areas of the building. Accordingly, there is a need to develop new mounting assemblies for lighting fixtures, such as overhead lighting fixtures, which provide adjustability (e.g., tilt adjustment) of the lighting fixture while facilitating a more efficient installation method to reduce the cost and/or the time to mount the lighting fixtures.

### SUMMARY

One embodiment relates to a mounting assembly for attaching a lighting fixture to an overhead structure. The mounting assembly includes a first member and a second member. The first member is configured to be coupled to the overhead structure and includes a base with an opening provided therein. The second member is configured to be coupled to the fixture and includes a body and an catch extending from the body. The catch is configured to engage the opening to pivotally connect the second member to the first member, such that the base is substantially parallel to the body.

Another embodiment relates to a lighting fixture configured to attach to an overhead structure. The lighting fixture includes a structural frame configured to house and support at least one light producing element and a mounting assembly for attaching the frame to the overhead structure. The mounting assembly includes a first member and a second member. The first member is configured to be coupled to the overhead structure and includes a base with an opening provided therein. The second member is configured to be coupled to the fixture and includes a body and an catch extending from the body. The catch is configured to engage the opening to pivotally connect the second member to the first member, such that the base is substantially parallel to the body.

Yet another embodiment relates to a method for mounting a lighting fixture to an overhead structure. The method includes mounting a lower member to a frame of the lighting fixture, mounting an upper member to a section of the overhead structure, and operatively connecting the lower member to the upper member. The upper member has a base with an opening therein, and the lower member has an catch that passes through the opening in the upper member and engages an edge of the base, such that the edge pivotally supports the catch.

### BRIEF DESCRIPTION OF THE DRAWINGS

FIG. 1 is a perspective view of an exemplary embodiment of a lighting fixture having a mounting assembly for attaching the lighting fixture to an overhead structure.

FIG. 2 is another perspective view of the lighting fixture of FIG. 1.

FIG. 3 is a right-side view of the lighting fixture of FIG. 1.

FIG. 4 is a left-side view of the lighting fixture of FIG. 1.

FIG. 5 is a top view of the lighting fixture of FIG. 1.

FIG. 6 is a front view of the lighting fixture of FIG. 1.

FIG. 7 is a perspective view of an exemplary embodiment of a mounting assembly configured to attach a lighting fixture, such as the lighting fixture of FIG. 1, to an overhead structure.

FIG. 8 is another perspective view of the mounting assembly of FIG. 7.

FIG. 9 is a right-side view of the mounting assembly of FIG. 7.

FIG. 10 is a top view of the mounting assembly of FIG. 7.

FIG. 11 is a left-side view of the mounting assembly of FIG. 7.

FIG. 12 is a bottom view of the mounting assembly of FIG. 7.

FIG. 13 is a front view of the mounting assembly of FIG. 7.

FIG. 14 is a rear view of the mounting assembly of FIG. 7.

FIG. 15 is a cross-sectional view taken along line 15-15 of FIG. 11.

FIG. 16 is another cross-sectional view taken along line 16-16 of FIG. 11.

FIG. 17 is a perspective view of an exemplary embodiment of a lower member of the mounting assembly of FIG. 7.

FIG. 18 is another perspective view of the lower member of FIG. 17.

FIG. 19 is a perspective view of an exemplary embodiment of an upper member of the mounting assembly of FIG. 7.

FIG. 20 is a perspective view of the lighting fixture of FIG. 1 with a portion of the fixture removed to show the mounting assembly connecting the frame.

FIG. 21 is a cross-sectional view of the fixture of FIG. 21 showing the mounting assembly coupled to the frame of the lighting fixture.

### DETAILED DESCRIPTION

Referring generally to the Figures, disclosed herein are mounting assemblies configured to mount (e.g., attach, secure, connect, couple) a fixture to an overhead structure. For example, the mounting assemblies as disclosed herein may attach a lighting fixture to a structure of a ceiling. The mounting assemblies as disclosed herein may include a first member configured to be coupled to the overhead structure and a second member configured to be coupled to the lighting fixture. The second member may be pivotally connected to the first member to allow for moving (e.g., tilting or aligning) of the fixture relative to the overhead structure. For example, the second member may include a catch (e.g., an arm, a hook, etc.) that is configured to engage a receiving feature (e.g., an aperture, an opening, etc.) of the first member to allow the first and second member to be pivotally connected without having to use other elements (e.g., fasteners) or tools (e.g., wrenches, screwdrivers, etc.). This arrangement may advantageously allow one person to install the lighting fixture to the structure in a timely manner. For example, the single installer may attach the two first members of the mounting assembly to the ceiling, which may include using a template to help in locating the proper positions (e.g., spacing) of the first members. The template may be easily utilized by the single installer, and may ensure proper alignment between the first and second members, such as so the catches are able to properly engage the receiving features. It is noted that although it may be preferable to have a single person install the lighting fixtures, as disclosed herein, to the supporting structures, that more than one person may cooperate to install the lighting fixtures. Then, the installer(s) may couple the two second members to the lighting fixture and move (e.g., lift) the lighting fixture into a position where the catches of the second members engage the respective receiving feature of the first members to pivotally couple the first and second members. Once the catches and receiving features of the mounting assembly are engaged, the lighting fixture will remain attached (e.g., suspended) from the structure of the ceiling and will self-level due to the weight of the lighting fixture causing the catches to find a position (e.g., a downward position) relative to the receiving features. The self-leveling aspect of the mounting assembly may advantageously speed up the installation process by eliminating or greatly reducing the need for the installer to level the lighting fixture.

The mounting assemblies as disclosed herein may also be configured to lock in an adjusted position. The adjusted position may be where the lighting fixture is generally parallel with the ceiling or may be configured where the lighting fixture is aligned at an angle (e.g., not parallel) relative to the ceiling. For example, after engaging the catches and receiving features, the installer(s) may move (e.g., tilt) the lighting fixture relative to the ceiling, since the first and second members are pivotally coupled to find a desired position (e.g., orientation, alignment, etc.) of the lighting fixture relative to the ceiling. Once the lighting fixture is located in the desired position, the installer(s) may secure the position, such as, for example, by clamping the first and second members of the mounting assemblies together with a fastener (e.g., nut and bolt) or any suitable clamping device.

The mounting assemblies as disclosed herein provide numerous advantages over existing mounting brackets. For example, the mounting assemblies as disclosed herein may advantageously be attached to the overhead structure (e.g., ceiling) by a single installation person (e.g., installer), as opposed to needing at least a two-person installation crew. Also, for example, the mounting assemblies as disclosed herein may advantageously allow for easier and faster adjustment of the mounting assembly/fixture to the desired angle of alignment, and may advantageously allow for easier and faster securing of the mounting assembly/fixture to the desired angle of alignment. These advantages may translate into cost savings, because the overhead and time spent on installation is reduced. The cost savings may become particularly significant when the building has a relatively large footprint with numerous lighting fixtures. For example, many agricultural facilities or buildings, such as dairy farms, are configured to house hundreds or thousands of livestock, where the facility has a vast number of overhead lighting fixtures to illuminate the facility. Accordingly, the greater number of overhead fixtures translates in a greater cost savings for the facility by using the fixtures as disclosed herein. It is noted that the mounting assemblies and fixtures disclosed herein may be used in any type of building or structure that utilizes overhead lighting. For example, the lighting fixtures as disclosed herein may be configured for use in exterior lighting applications, such as where the lighting fixture is suspended from a support structure.

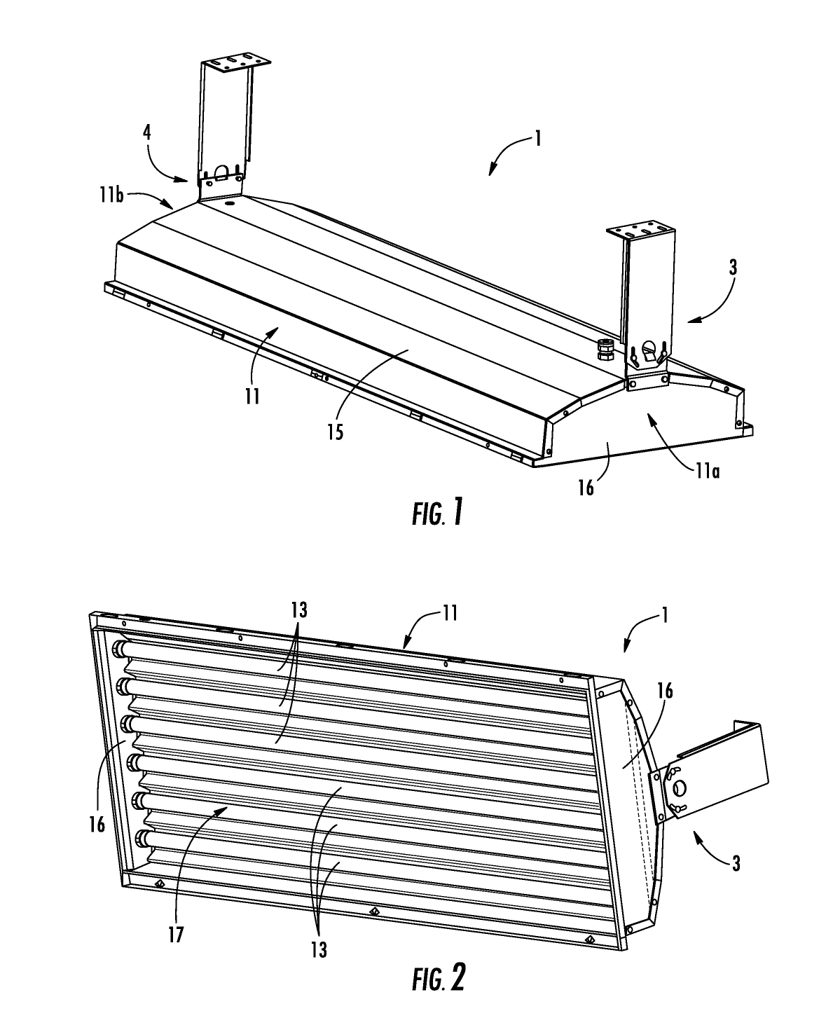

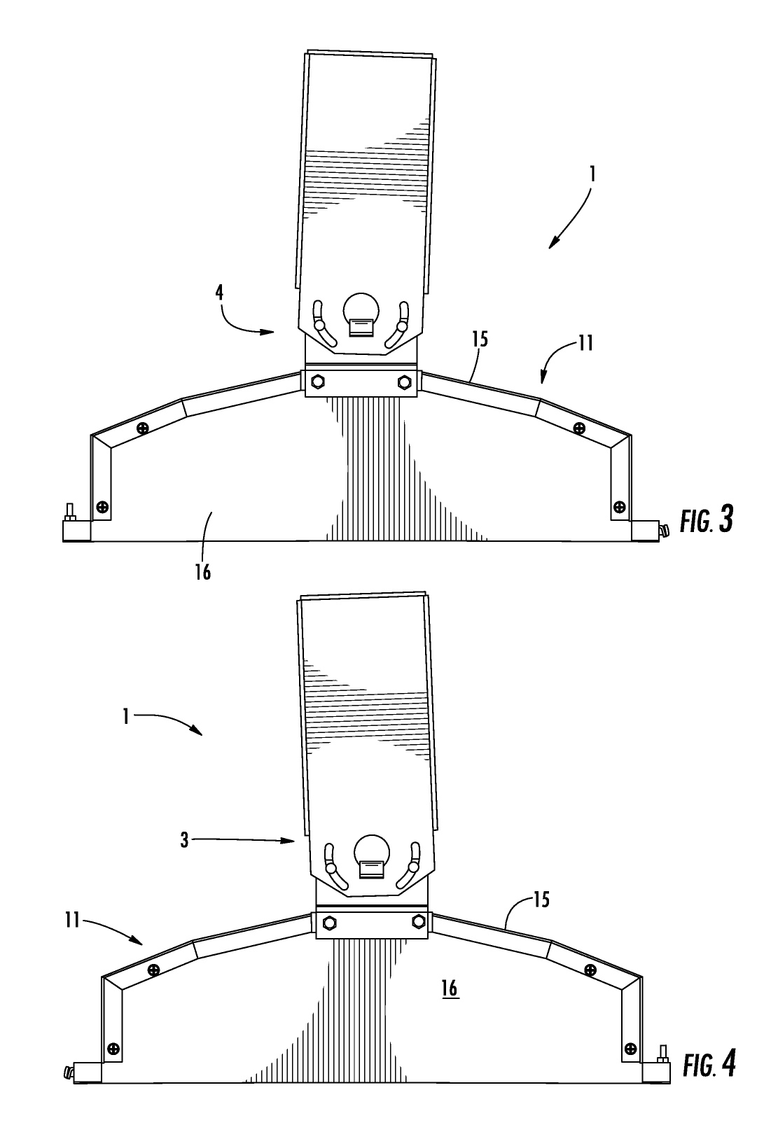

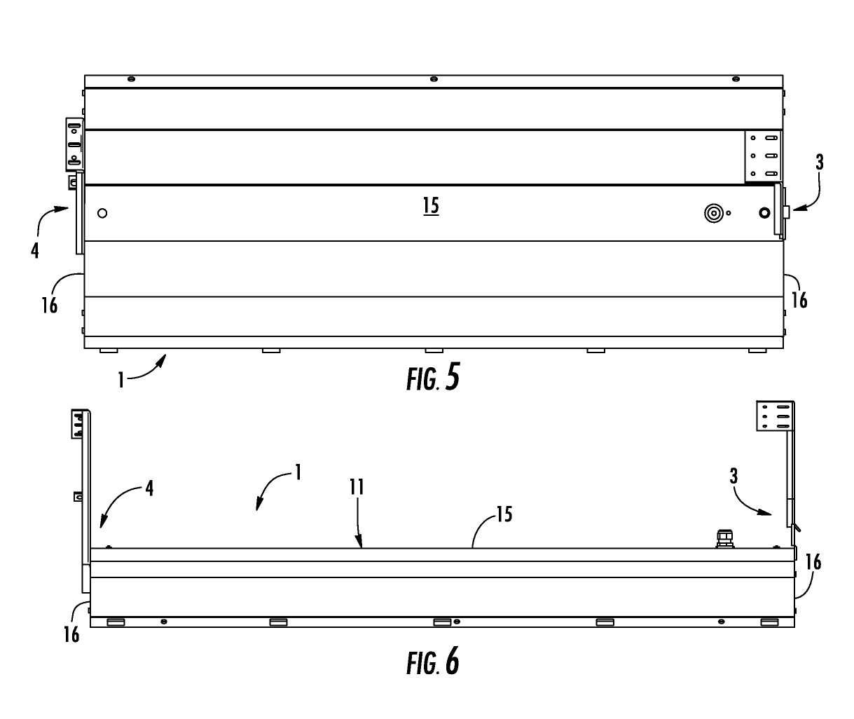

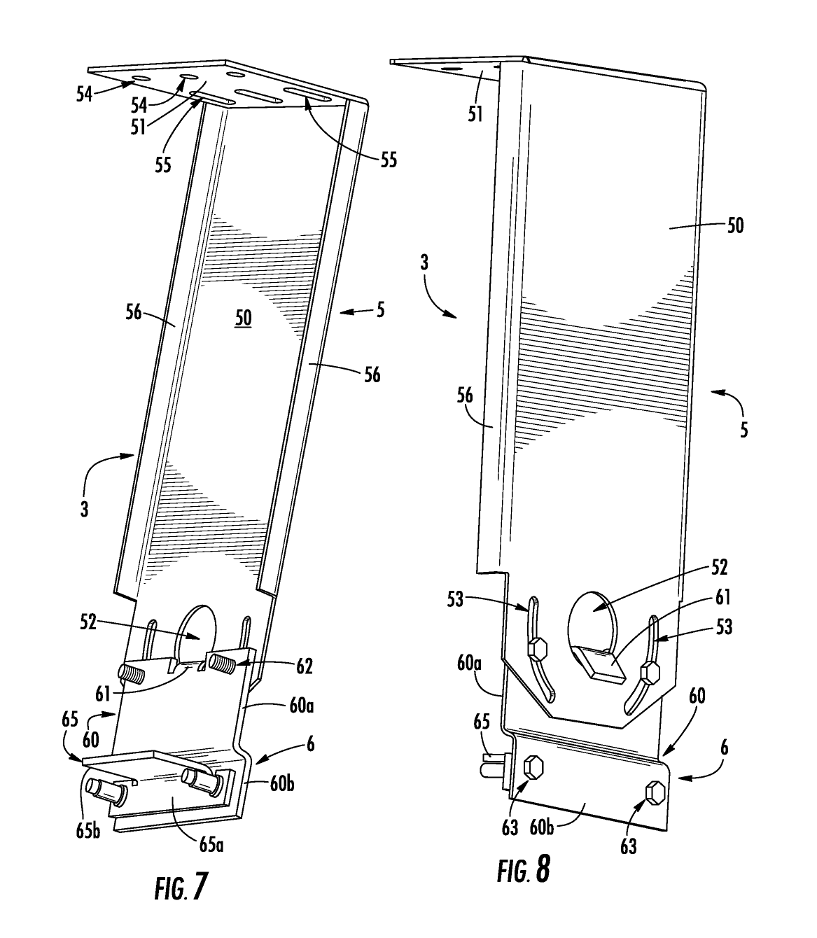

FIGS. 1-6 illustrate an exemplary embodiment of a lighting fixture 1 having a mounting system for attaching the lighting fixture 1 to an overhead structure, such as a ceiling of a building. The lighting fixture 1 may have any suitable configuration (e.g., shape, size, etc.). As shown, the lighting fixture 1 has an elongated body 11 that is configured to support one or more than one light producing element 13 (e.g., light bulb). The body 11 may include one or more than one member (e.g., element, support, bracket, plate, etc.) configured to provide a frame or a structure for the lighting fixture 1. For example, the body 11 may include an elongated cover 15 (e.g., a upper member) having a generally C-shaped cross-sectional and a pair of end members 16 (e.g., side members) provided at opposing ends of the cover 15 to define a cavity 17 that is configured to receive the one or more light producing elements 13. In other words, the body 11 may be polyhedron shaped with an open surface that defines the cavity 17 to house the light producing elements 13 therein.

The lighting fixture 1 may also include electronics (e.g., wiring, connectors, etc.) configured to receive and transfer the electric power from a power supply to the light producing elements 13. For example, the electronics (and other elements of the lighting fixture) may be housed in the body 11. The lighting fixture 1 may also include a lens (not shown), such as a transparent or translucent lens that is configured to be provided over the open surface of the body 11 to enclose the light producing elements 13 in the cavity 17. The lens may protect the light producing elements 13 and other elements within the cavity 17 from dust, contaminants, fluids, etc. It is noted that the lighting fixture 1 may include other components and/or elements, and those components and elements disclosed herein are examples and are not limiting.

The light producing elements 13 may be configured as any suitable device that may produce light, such as from electric power. For example, the light producing elements 13 may be fluorescent lamps, incandescent bulbs, light-emitting diodes (LEDs), phosphorescent lamps, or any other suitable type of electric lights.

The mounting system may include one or more than one mounting assembly. As shown, the mounting system includes a first mounting assembly 3 attached to a first end 11a of the body 11 and a second mounting assembly 4 attached to a second end 11b of the body 11. However, it is noted that the first and second mounting assemblies 3, 4 may be attached anywhere on the lighting fixture 1, such as anywhere on the body 11. For example, the first and second mounting assemblies 3, 4 may be attached to a lower cross-member of the body 11. As another example, the first and second mounting assemblies 3, 4 may be attached to the cover 15. Accordingly, the configuration of the first member 5 and/or second member 6 may be modified to facilitate the attachment of the respective member to another part or portion of the lighting fixture 11, such as to the cover 15 or a lower cross-member. The first mounting assembly 3 may be configured to attach to a first location of the overhead structure, and the second mounting assembly 4 may be configured to attach to a second location of the overhead structure, such as to support the lighting fixture 1 at two locations. The mounting assemblies (e.g., the first mounting assembly 3, the second mounting assembly 4) may be similarly or differently configured, as described in greater detail below.

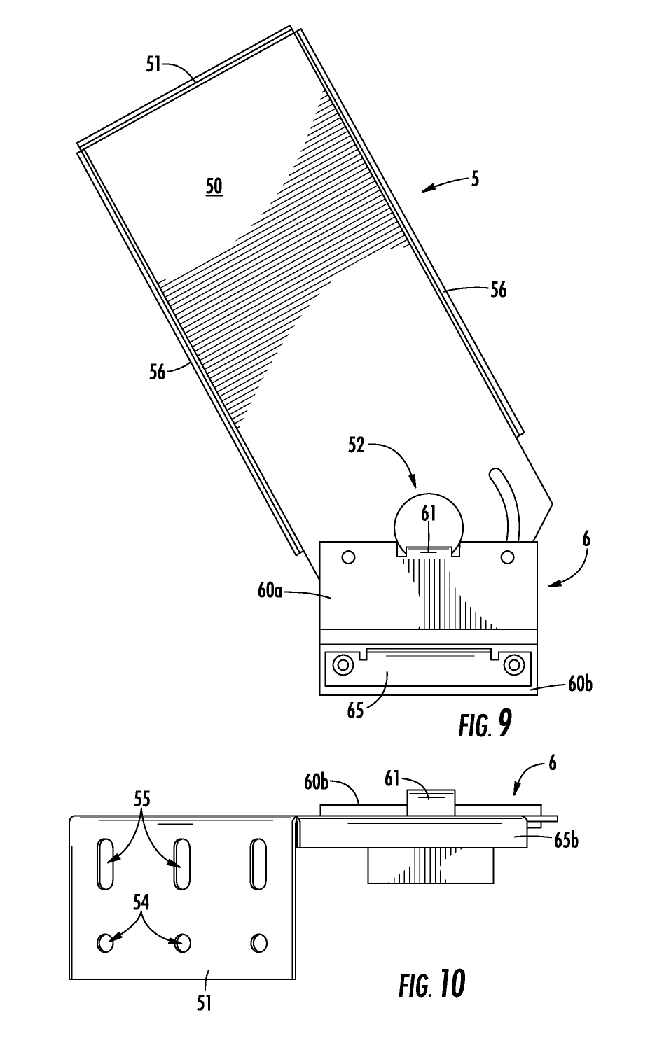

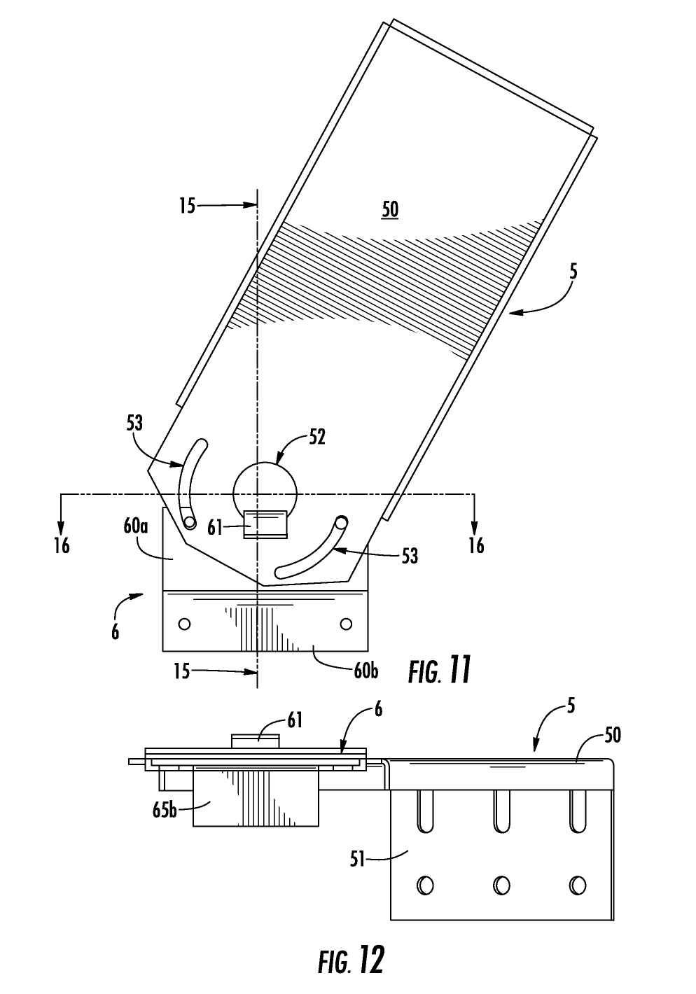

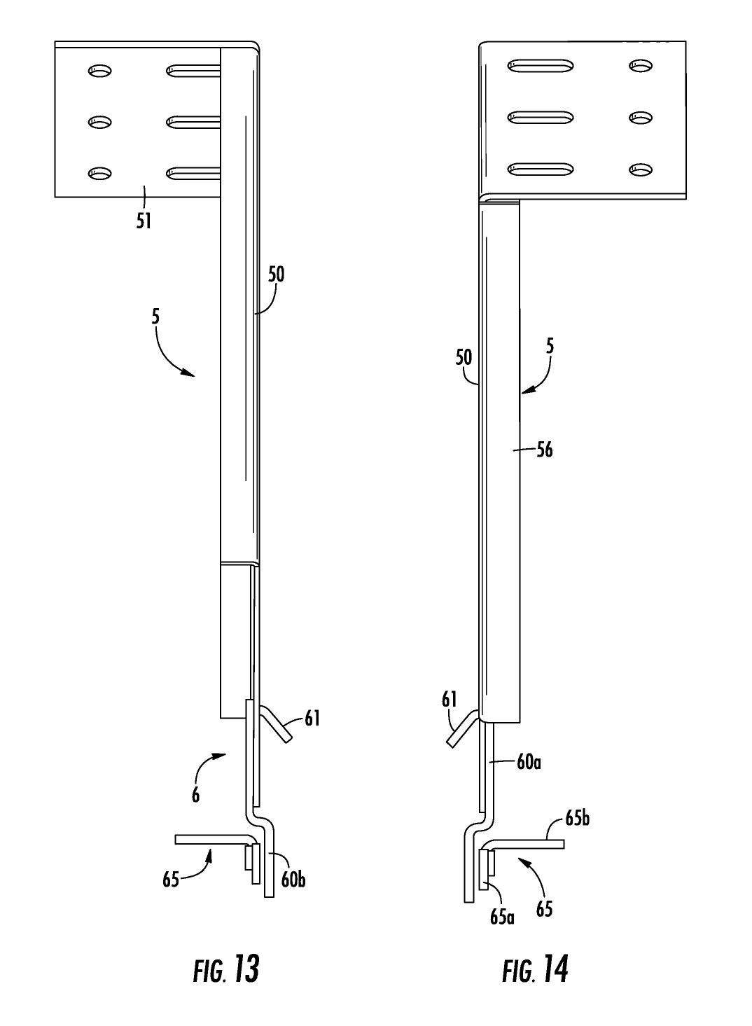

FIGS. 7-16 illustrate an exemplary embodiment of a mounting assembly 3 (e.g., a first mounting assembly) configured to attach or couple to a fixture, such as the lighting fixture 1, and to an overhead structure (not shown). As shown, the mounting assembly 3 includes a first member 5 (e.g., a upper member) and a second member 6 (e.g., a lower member). The first member 5 may be configured to be coupled to the overhead structure and may be pivotally connected or coupled to the second member 6. The second member 6 may also be configured to be coupled to the lighting fixture 1, such as to the body 11.

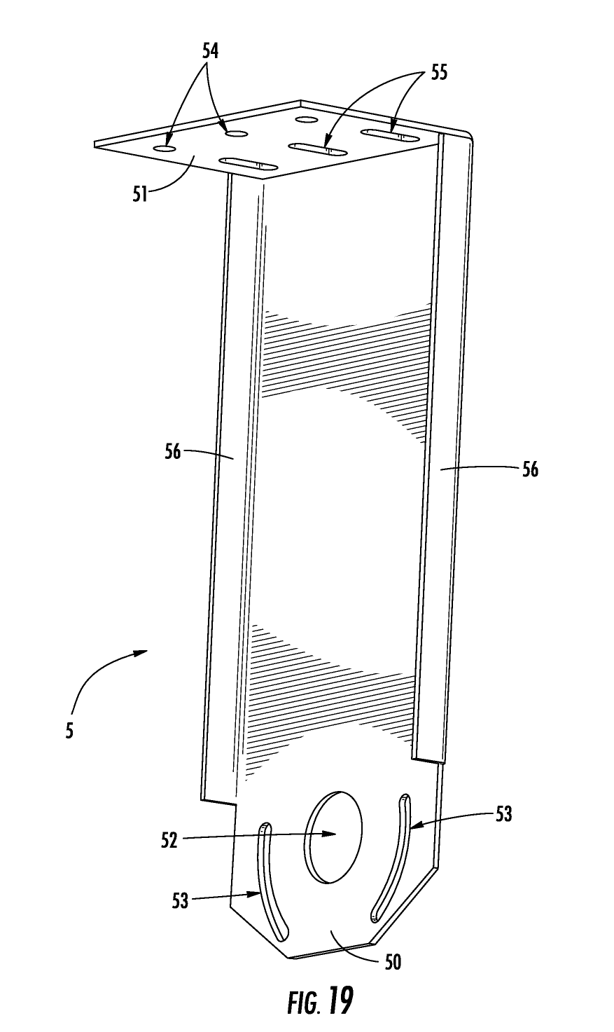

FIG. 19 illustrates an exemplary embodiment of the first member 5 for use in the mounting assembly 3. As shown, the first member 5 includes a base 50 and a flange 51 extending from an end of the base 50. The base 50 may be configured as a substantially flat plate having an opening 52 provided therein. For example, the opening 52 may be disposed near the end opposing the end having the flange 51. The opening 52 is configured to help pivotally couple the first member 5 to the second member 6, and may have any suitable configuration (e.g., shape, size, location). For example, the opening 52 may have a circular shape.

The base 50 of the first member 5 may also include an aperture 53 (e.g., a hole, an opening, a slot, etc.) configured to define a travel stop to limit the relative rotational travel between the first member 5 and the second member 6. As shown in FIG. 19, the base 50 includes two apertures 53 provided on opposing sides of the opening 52, where the apertures 53 cooperate with the second member 6 to limit the rotational travel of the first member 5 relative to the second member 6. Each aperture 53 may have any suitable configuration (e.g., shape, size, location). For example, each aperture 53 may be configured as an arcuate or curved shape slot, where each arcuate aperture 53 may be configured substantially concentric to the circular shaped opening 52. This arrangement of the aperture 53 allows a portion of the second member 6 to move in the arcuate slot between the closed ends of the aperture 53, such as when the second member 6 rotates relative to the first member 5, where the closed ends define travel stops between the members. It is noted that the aperture 53 may be located anywhere on the first member 5 wherein it can effectively act to limit a rotational travel of the second member 6 relative to the first member 5 and/or may be configured to not be concentric with the opening 52.

The flange 51 may extend in a substantially perpendicular direction from the base 50, and is configured to be coupled to another component, such as to an overhead structure. The flange 51 may include features to facilitate coupling the first member 5 to the overhead structure. For example, the flange 51 may have one or more than one hole configured to receive a fastener or other device to couple the flange 51 to the overhead structure. As shown, the flange 51 includes a plurality of circular holes 54 and a plurality of slotted holes 55 that are configured to facilitate coupling the first member 5 to the other component.

The first member 5 may also include strengthening features configured to increase the relative strength of the first member 5. The strengthening features may have any suitable configuration. For example, the strengthening features may be configured as additional flanges, ribs, and/or embosses. As shown in FIG. 19, the first member 5 includes a pair of opposing side-flanges 56 extending from the sides of the base 50, such as perpendicular to the base 50. Each side-flange 56 may extend a length from the flange 51 to the opposing end of the base 50, or may extend any length less than the distance between the flange 51 and the opposing end of the base 50. Further, each side-flange 56 may extend any height from the base 50, where the height may be configured to tailor the strength of the first member 5.

FIGS. 17 and 18 illustrate an exemplary embodiment of a second member 6 for use in the mounting assembly 3. The second member 6 may be configured to be pivotally coupled to the first member 5 and to attach or couple to a fixture, such as the lighting fixture 1. As shown, the second member 6 includes a body 60 and a catch 61 (e.g., an arm, an extension, a hook, etc.) extending from the body 60.

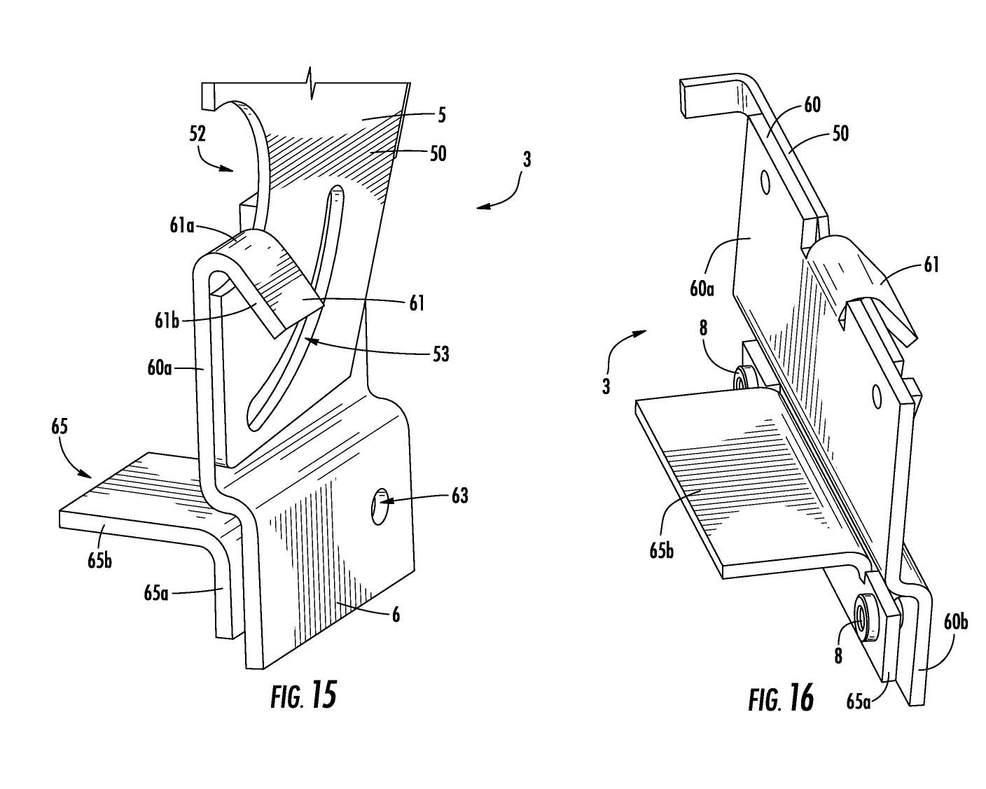

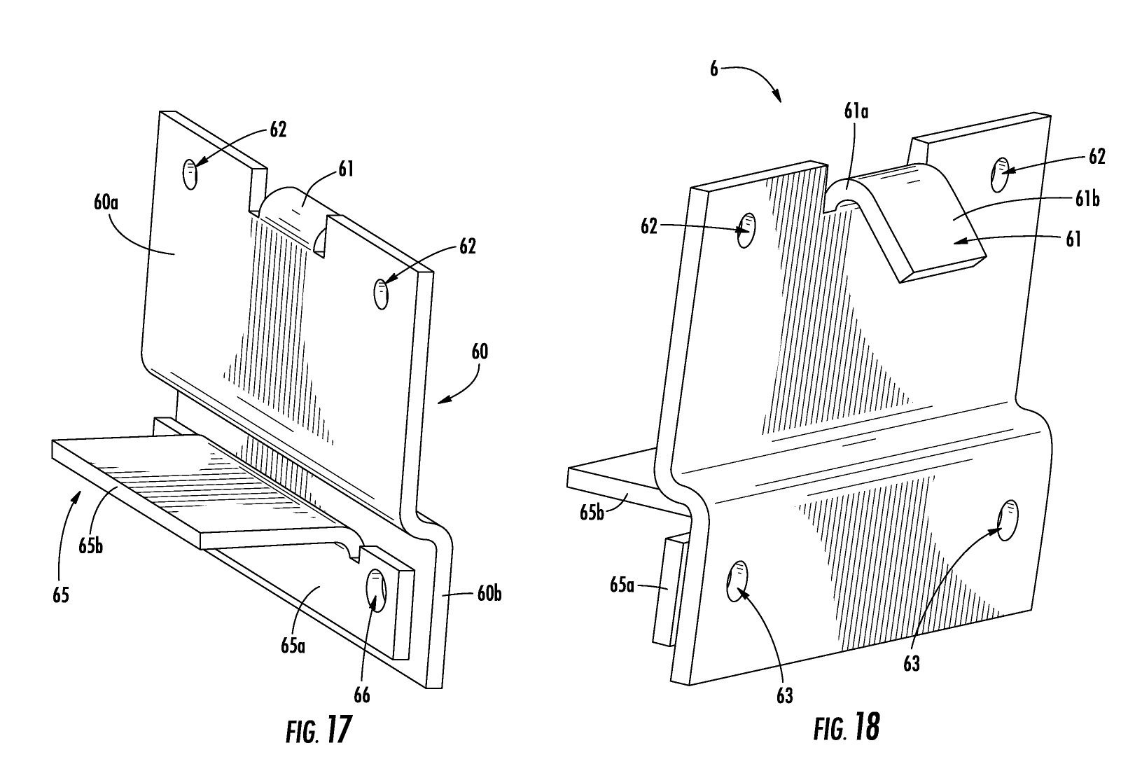

The body 60 of the second member 6 may be configured as a formed plate, such as, for example, having an upper portion 60a offset from a lower portion 60b. The upper portion 60a may have any suitable shape and configuration. For example, the upper portion 60a may be substantially flat to facilitate placement adjacent to or otherwise proximate to the substantially flat base 50 of the first member 5 in an abutting arrangement, such as shown in FIGS. 15 and 16. Thus, the flat upper portion 60a and flat base 50 may be configured to provide surfaces that support one another structurally and provide bearing surfaces, such as during relative rotation between the first member 5 and the second member 6.

The upper portion 60a of the body 60 may also include one or more than one feature, such as stop feature(s), to cooperate with the first member 5 to limit the relative rotation travel between the second member 6 and the first member 5. According to an exemplary embodiment, the upper portion 60a includes a projection that extends from the substantially flat upper portion 60a, where the projection is configured to engage one of two arcuate apertures 53 of the first member 5. The projection may move within the aperture 53 during relative rotation between the second member 6 and the first member 5. When the projection contacts a closed end of the aperture 53, the relative rotation between the first and second members 5, 6 is limited or stopped by the travel stop. According to another exemplary embodiment, the upper portion 60a includes an opening 62 that is configured to receive a post, stud, fastener, or other suitable member that engages both the opening 62 of the second member 6 and the aperture 53 of the first member 5 to act as a travel stop to limit the relative rotation between the first and second members 5, 6. It is noted that the feature of the second member 6 that cooperates with the first member 5 to provide a travel stop or travel limit may be configured differently than the examples as disclosed herein, and the examples are not limiting. Further, the upper portion 60a may include more than one travel stop feature, such as having a plurality of projections, where each projection is configured to engage one aperture (e.g., arcuate slot). For example, the upper portion 60a may include two projections provided on opposing sides of the catch 61, where each projection of the second member 6 engages one of two opposing apertures 53 of the first member 5.

According to yet another exemplary embodiment, the stop feature is configured to selectively engage the first member 5 and/or the second member 6 to thereby limit the relative movement therebetween. For example, the selectively engageable stop feature may include one or more than one moveable element (e.g., retractable pin) that is configured to be moved between a first engaging position and a second disengaging position. In the engaging position, the moveable pin(s) may engage the first member 5 and/or the second member 6 to thereby limit the relative movement between the members. In the disengaging position, the moveable pin(s) may be disengaged from the first member 5 and/or the second member 6 to allow the members to move freely with respect to one another. Also, for example, the selectively engageable stop feature may include a resilient member (e.g., a rubber isolator, an elastomeric member, etc.) that is configured to be compressed upon relative movement between the first and second members 5, 6, such as, movement beyond a threshold position, which thereby increases a compressive force between the resilient member and another member (e.g., first member, second member, another plate or member, etc.).

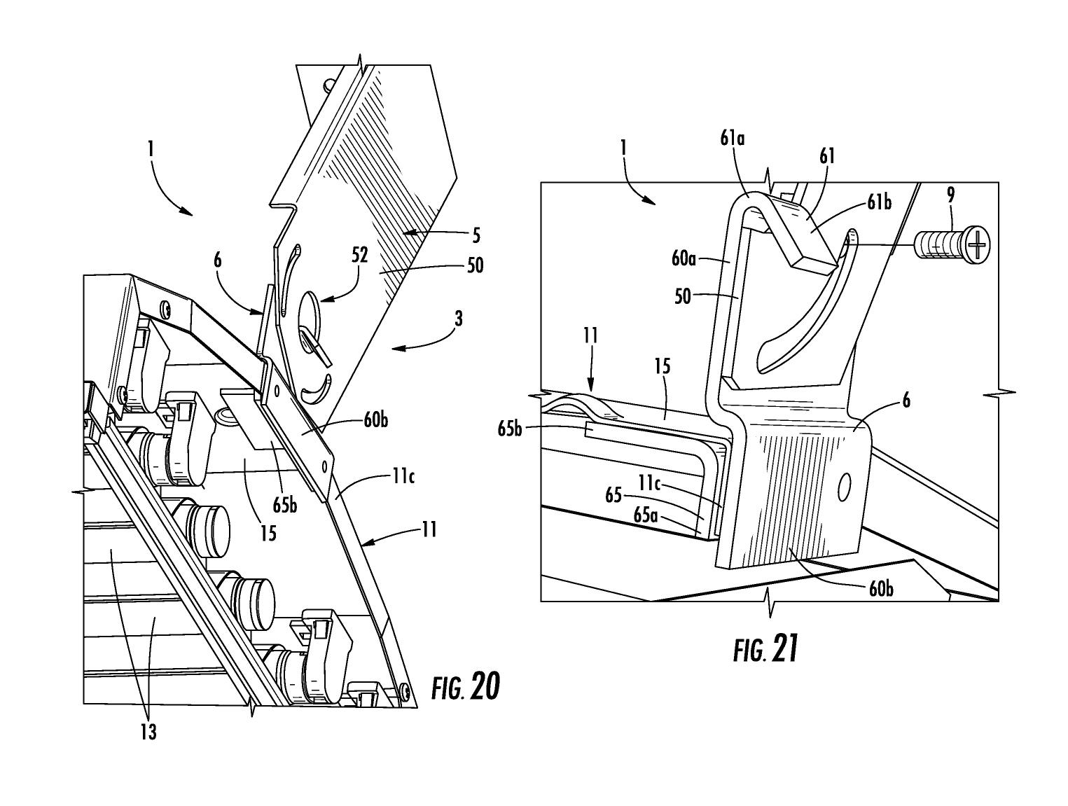

The lower portion 60b of the body 60 may have any suitable shape and configuration, such as for attaching to the body 11. For example, the lower portion 60b may be substantially flat to mate with a surface of the lighting fixture 1, such as with a surface of the body 11. As shown in FIGS. 20 and 21, the lower portion 60b may be configured to be connected to or mated with the flange 11c of the body 11. This arrangement may provide a solid structural joint or connection between the second member 6 of the mounting assembly 3 and the body 11 of the lighting fixture 1. The lower portion 60b may also include features to facilitate coupling the second member 6 to the lighting fixture 1, such as directly to the body 11 or to the body 11 and a support member 65. For example, the lower portion 60b may include a hole that is configured to receive a fastener or other device to couple the second member 6 to the body 11. As shown in FIG. 18, the lower portion 60b includes a pair of circular holes 63 (e.g., opening, aperture, etc.) provided on opposing sides of the lower portion 60b to provide a longer spacing between the holes 63 to better manage the loads or forces transmitted into the mounting assembly 3. Each hole 63 may be configured as a through hole where the fastener may engage a nut or other device to connect the second member 6 to the body 11 (and/or the support member 65), or as a tapped hole where the threads of the fastener engage mating threads of the hole 63. It is noted that the lower portion 60b may include any number of holes having any suitable configuration (e.g., shape, size, location), and the examples disclosed herein are not limiting.

The catch 61 of the second member 6 may be configured to engage the opening 52 of the first member 5, such as to pivotally connect the second member 6 to the first member 5. The catch 61 may have any suitable configuration (e.g., shape, size, location) for engaging a receiving feature (e.g., the opening 52), such as to help suspend a fixture (e.g., the lighting fixture 1) from a structure (e.g., a ceiling). As shown in FIGS. 17 and 18, the catch 61 has a generally J-shaped cross-section and it extends generally away from the upper portion 60a of the second member 6. For example, the catch 61 may include a first portion 61a (e.g., curved portion) and a second portion 61b (e.g., flat portion) extending away from the first portion 61a. The first portion 61a may be integrally formed with or formed separately from and connected to the upper portion 60a of the second member 6. The second portion 61b may extend away from the first portion 61a in a downwardly oblique direction having an angle relative to the upper portion 60a of the body 60. The angle between the second portion 61b of the catch 61 and the upper portion 60a may be an acute angle in order to provide a locking geometry between the catch 61 and the first member 5. For example, the catch 61 configured at the acute angle (relative to the upper portion 60a) may act as a hook to retain the second member 6 to the first member 5, such as when the catch 61 engages a surface of the first member 5 that defines the opening 52. Thus, when the lighting fixture 1 is assembled, the weight of the lighting fixture 1 induces a downward force onto the second member 6 bringing the catch 61 into contact with the portion of the base 50 defining the opening 52 of the first member 5 to retain the second member 6. Further, this arrangement of the catch 61 of the second member 6 engaging the base 50 at the opening 52 of the first member 5 improves installation assembly by allowing for the members 5, 6 to be quickly pivotally coupled together without the use of additional components (e.g., fasteners, etc.). For example, the engaging feature (e.g., the catch 61, arm, extension, hook, etc.) and the receiving feature (e.g., the opening 52) allow the lighting fixture 1 to be temporarily hung (e.g., suspended) without the use of fasteners, which may advantageously allow the installer to level the lighting fixture, align (e.g., tilt) the lighting fixture at an angle relative to the ceiling, or for the mounting assembly 3 to self-level the lighting fixture 1.

As shown, the catch 61 is configured to contact the opening 52 along two lines of contact (e.g., the outer bottom edges of the catch 61). This arrangement may advantageously reduce the friction force between the first and second members 5, 6 and may also help to improve the self-aligning aspect of the mounting assembly 3. However, it is noted that the catch 61 of the second member 6 may have any suitable configuration and still may advantageously pivotally couple the members together without the use of additional components. For example, the catch 61 may be configured having a complimentary surface to the opening 52, such as, where the catch 61 includes a circular surface that acts as a bearing along the inner surface (e.g., inside diameter) of the opening 52. The catch 61 may also include a shoulder that is configured to be adjacent to the circular surface that contacts the opening 52 to retain the members together. A lubricant may be used with this example (or any other configuration) to help reduce the friction between the first and second members 5, 6. It is also noted that although the exemplary embodiments of the mounting assemblies (e.g., the mounting assembly 3) as disclosed herein are configured with the first member 5 having the receiving feature (e.g., the opening 52) and the second member 6 having the engaging feature (e.g., the catch), the second member 6 may be configured having the receiving feature (e.g., the opening) and the first member 5 may be configured having the engaging feature (e.g., the catch).

The second member 6 may also include the support member 65 to provide increased structural support to the connection between the body 11 and the mounting assembly 3 and/or provide a positive location of the second member 6 relative to the body 11 when the mounting assembly 3 is mounted or coupled to the body 11. The support member 65 may have any suitable configuration, which may be integrally formed with the second member 6, such as with the lower portion 60b, or may be formed separately from and coupled to the second member 6, either directly or through a section or portion of the body 11. As shown in FIG. 17, the support member 65 has a generally L-shaped cross-section and is formed separately from the lower portion 60b then coupled to the lower portion 60b through the body 11. The L-shaped support member 65 may include a first portion 65a (e.g., a vertical portion) and a second portion 65b (e.g., a horizontal portion) that extends generally away from an end of the first portion 65a.

The first portion 65a of the support member 65 may be configured to contact the lower portion 60b. Accordingly, the first portion 65a may be generally flat to mate with the lower portion 60b. As shown in FIGS. 20 and 21, the first portion 65a of the support member 65 may be offset from the lower portion 60b to sandwich a portion (e.g., a flange 11c) of the body 11 between the support member 65 and the second member 6. Thus, the support member 65 may clamp the flange 11c of the body 11 to the second member 6, such that the flange 11c is disposed between the first portion 65a of the support member 65 and the lower portion 60b of the second member 6. This arrangement may advantageously allow the body 11 to be made out of a thinner gauge material, while the support member 65 increases the strength of the lighting fixture 1 local to the mounting assembly 3 by distributing the loading through a larger surface area of the body 11.

The first portion 65a may include features to facilitate coupling to the lower portion 60b (when the support member 65 is not integrally formed with the second member 6). For example, the first portion 65a may include one or more than one hole 66 configured to receive a fastener therein to couple the support member 65 to the second member 6. Accordingly, the fastener(s) may be configured to pass through the support member 65, the portion of the body 11, and the second member 6 to couple the mounting assembly 3 to the body 11.

The second portion 65b of the support member 65 may be configured to contact a portion of the lighting fixture 1, such as a portion of the body 11 to add structural support to the body 11 and to provide a positive location for assembling the mounting assembly 3 to the body 11. For example, the second portion 65b configured to extend horizontally may be configured to abut a mating horizontal surface of the body 11 to align the mounting assembly 3 and body 11, such as relative to the vertical direction. Further, the second portion 65b may distribute loading across a relatively large surface area of the contacting surface of the body 11. The second portion 65b may include features, such as holes, to facilitate coupling the second portion 65b to another component, such as of the body 11 to secure the second member 6 to the body 11.

FIGS. 15 and 16 illustrate various cross-sectional views through the mounting assembly 3. FIG. 15 illustrates the second member 6 connected to the first member 5 with the section being cut by a vertical plane through the catch 61 of the second member 6 engaging the opening 52 of the first member 5. As shown, the catch 61 is configured to wrap around or hook onto a portion of the base 50 around the opening 52. Thus, an inside surface of the catch 61, such as the inside surface of the first portion 61a, engages an inner surface (e.g., an inner edge of a circumference) of the base 50 that is defined by the circular opening 52. The mounting assembly 3 having this arrangement may advantageously be self-leveling. For example, the force of gravity acting on a mass of the fixture (e.g., the mass of the second member 6 and coupled body 11) may influence the second member 6 to move relative to the first member 5, such that the catch 61 may slide along the curved inner surface defined by the opening 52 of the base 50 to find a location on the curved inner surface that is substantially at the downward most position. In other words, the weight of the lighting fixture 1, such as when suspended from the ceiling, may cause the second member 6 to move to a position (e.g., a home position, a downward position) relative to the first member 5. The self-leveling aspect of the mounting assembly 3 may advantageously decrease the time required to install the lighting fixture 1 to the structure of the ceiling by eliminating the need for the installer to level the lighting fixture 1. In addition, the self leveling aspect may advantageously allow the installer to perform the installation with less tools (e.g., a level). According to an exemplary embodiment, the mounting assembly 3 may self-level the lighting fixture 1 to within about 5° (five degrees). FIG. 16 illustrates the upper portion 60a of the second member 6 contacting the base 50 of the first member 5 in an abutting arrangement with the section being cut by a horizontal plane through the base 50 and upper portion 60a just above the catch 61.

The mounting assembly 4 may be configured to be similar to or different than the mounting assembly 3. For example, the mounting assembly 4 may be configured to be generally symmetrically opposite to the mounting assembly 3, such that the mounting assembly 3 may be provided on a first side of the body 11 and the mounting assembly 4 may be provided on a second opposing side of the body 11. Further, the mounting assembly 4 may include a first member that is configured the same as, similar to, or different than the first member 5 of the mounting assembly 3, and may also include a second member that is configured the same as, similar to, or different than the second member 6 of the mounting assembly 3.

An exemplary method of installation (e.g., attaching or mounting the lighting fixture 1 to the overhead structure through the mounting assembly 3) will now be described. According to an exemplary embodiment, the lighting fixture 1 may be mounted or coupled to the overhead structure, such as the ceiling of the building, using a five step mounting or installation process.

The first step involves attaching the second member 6 to the lighting fixture 1, such as to the body 11, which can be done prior to shipping by the manufacturer or after shipping by a single installation person. As shown in FIGS. 20 and 21, the support member 65 may be provided on the inside surface of the flange 11c of the body 11 and the second member 6 may be provided on the outside surface of the flange 11c. In other words, the second member 6 may be coupled to the body 11 by clamping the flange 11c between the second member 6 and the support member 65. For example, fasteners, such as the screws 8 shown in FIG. 16, may be used to clamp the second member 6 and support member 65 to the flange 11c. The fasteners may secure the second member 6 to the body 11 of the lighting fixture 1, with or without the support member 65.

The second step involves attaching or connecting the first member 5 to the overhead structure, such as to the ceiling of the building. The flange 51 of the first member 5 may be brought into contact with a portion of the overhead structure, such as with a section of a ceiling joist, where fastener(s) may couple the flange 51 to the joist through the holes, such as the circular hole(s) 54 and/or the slotted hole(s) 55. It is noted that the location on the overhead structure to which the fixture is to be mounted may be predetermined, such as through the use of a template, form, jig, or any suitable device to aid the installer in locating the section or portion of the overhead structure to which the fixture is to be mounted. For example, the installer may use a template that defines the locations on the section of the joist into which the fastener(s) may be driven to couple the flange 51 to the overhead structure. The template may have any suitable configuration (e.g., shape, size, etc.) for helping the installer determine the proper mounting locations of the mounting assemblies to the ceiling. For example, the template may be a plate made from any suitable material (e.g., metal, polymeric, composite, etc.) having one or more holes provided in the plate which correspond to the mounting locations for attaching the lighting fixture to the ceiling through the mounting assemblies (e.g., mounting assembly 3, mounting assembly 4). By utilizing the template to predetermine the correct location of the holes, the installer may help ensure proper mounting of the lighting fixture without having to reposition or bend a member or bracket of the assembly. Further, utilizing the template ensures proper alignment between the adjacent and/or mating surfaces of the members (e.g., first member 5, second member 6).

The third step involves attaching or connecting the second member 6 (and thereby the lighting fixture 1 coupled thereto) to the first member 5. The second member 6 may be operatively connected to the first member 5 so that the second member 6 may pivot relative to the first member 5, such as to adjust the tilt or alignment of the lighting fixture 1. As shown in FIGS. 15 and 21, the second member 6 (having the lighting fixture 1 coupled thereto) may be lifted into engagement with the first member 5 by passing the second portion 61b of the catch 61 of the second member 6 through the opening 52 of the first member 5, then moving the second member 6 downward relative to the first member 5 to catch or hook the catch 61 onto the base 50 of the first member 5. For example, the installer(s) may lift the lighting fixture 1 having the second members 6 of the mounting assemblies 3, 4 coupled to the body 11 into an elevated position where the catch 61 of the second member 6 of the first mounting assembly 3 is aligned with the opening 52 of the first member 5 of the first mounting assembly 3 to thereby engage the catch 61 and opening 52. Then, while the first side of lighting fixture 1 is hung (e.g., suspended) through the first mounting assembly 3, the installer(s) may align the catch 61 of the second member 6 of the second mounting assembly 4 with the opening 52 of the first member 5 of the second mounting assembly 4 and engage the catch 61 and opening 52 to thereby couple the second side of the lighting fixture 1.

The fourth step involves tilting or aligning the lighting fixture 1 relative to the overhead structure (and the first member 5). The mounting assembly 3 allows for the lighting fixture 1 to be self-leveled through the mounting assembly 3, since the second member 6 may pivot relative to the first member 5 as the catch 61 of the second member 6 may move along the surface defining the opening 52 of the first member 5. In addition, the installation person may align or tilt the lighting fixture 1 at an angle relative to the overhead structure. For example, the installer may tilt the lighting fixture 1, causing the catch 61 and second member 6 to pivot relative to the first member 5 (and overhead structure), such as to change the direction in which the lighting fixture 1 faces in order to shine the light in a different direction other than vertically downward. It is noted that the fourth step is an optional step, as the tilting or aligning of the lighting fixture 1 does not have to be performed when installing or mounting the lighting fixture 1 to the overhead structure. For example, the fourth step may be optional, because the lighting fixture 1 may be hung then allowed to self-level, as discussed herein, prior to securing the first and second members 5, 6 together. The self-leveling aspect of the lighting fixtures having mounting assemblies as disclosed herein may occur in a relatively short period of time, such as in the time between hanging the lighting fixture and preparing the fasteners or other elements for fixing the relative positions of the members.

The fifth step involves fixing the position of the second member 6, and thereby the lighting fixture 1 coupled thereto, relative to the first member 5. Once the desired angle of alignment between the lighting fixture 1 and the overhead structure is obtained, the specific position of the second member 6 relative to the first member 5 may be fixed. For example, fastener(s), such as the screw 9 shown in FIG. 21, may be configured to pass through the aperture(s) 53 of the first member 5 to thread into the opening(s) 62 of the second member 6, where each screw 9 imparts a clamp force between the first and second members 5, 6 to maintain the angle of tilt (e.g., the alignment) of the lighting fixture 1 relative to the overhead structure. For example, the lighting fixture 1 may be self-leveled with respect to the ceiling or may be aligned at an angle relative to the ceiling, such as to direct the light in a direction toward a given location. The screw 9 may have any suitable configuration, such as having self-tapping threads.

According to other exemplary methods of installing the lighting fixtures as disclosed herein, the steps may be altered from the above example to have any suitable arrangement of steps. For example, the first and second steps in the above example may be reversed in the order of installation, such that the first step involves attaching the first member 5 to the overhead structure, such as using the template, and the second step involves attaching the second member 6 to the lighting fixture 1, such as to the body 11.

The fixtures and mounting assemblies for mounting the fixtures to overhead structures, as disclosed herein, may advantageously be attached or mounted to the overhead structure (e.g., ceiling) by one person (i.e., a single installer), may advantageously allow for easier and faster adjustment of the mounting assembly/fixture to the desired angle of alignment, and may advantageously allow for easier and faster securing of the mounting assembly/fixture to the desired angle of alignment. Thus, the exemplary embodiments of the lighting fixtures as disclosed herein may be attached, such as using the exemplary methods of installing the lighting fixtures as disclosed herein, to a structure by a single installation person. It is noted that the lighting fixtures as disclosed herein may be installed by more than one person cooperating together to install the lighting fixtures.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the mounting assemblies or systems as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A lighting fixture configured to attach to an overhead structure, comprising:
a structural frame configured to house and support at least one light producing element;
a mounting assembly for attaching the frame to the overhead structure, the mounting assembly including:
a first member configured to be coupled to the overhead structure, the first member having a base with an opening provided therein; and
a second member configured to be coupled to the fixture, the second member having a body and an catch extending from the body;
wherein the catch is configured to engage the opening to pivotally connect the second member to the first member, such that the base is substantially parallel to the body.

2. The lighting fixture of claim 1, wherein the first member also includes a flange extending from an end of the base, the flange being configured to attach to the overhead structure.

3. The lighting fixture of claim 1, wherein the first member also includes an aperture that is configured to receive a portion of the second member to define a limit of relative rotation between the first and second members.

4. The lighting fixture of claim 3, wherein the aperture is an arcuate shaped slot that is configured to receive a post of the second member to define the limit of relative rotation between the first and second members.

5. The lighting fixture of claim 4, wherein the first member includes a second arcuate shaped slot located on the base on an opposing side of the opening relative to the first slot, the second slot being configured to receive a second post of the second member to limit the relative rotation between the first and second members.

6. The lighting fixture of claim 1, wherein the catch extends generally outward and downward to engage an inner surface of the opening of the base.

7. The lighting fixture of claim 1, wherein the first member also includes an aperture and the second member includes an opening, wherein the aperture of the first member and the opening of the second member receive a stud to define a limit of relative rotation between the first and second members.

8. A mounting assembly for attaching a lighting fixture to an overhead structure, comprising:
a first member configured to be coupled to the overhead structure, the first member having a base with an opening provided therein; and
a second member configured to be coupled to the fixture, the second member having a body and an catch extending from the body;
wherein the catch is configured to engage the opening to pivotally connect the second member to the first member, such that the base is substantially parallel to the body.

9. The mounting assembly of claim 8, wherein the first member also includes a flange extending from an end of the base, wherein the flange is configured to attach to the overhead structure.

10. The mounting assembly of claim 8, wherein the first member also includes an aperture that is configured to receive a portion of the second member to define a limit of relative rotation between the first and second members.

11. The mounting assembly of claim 10, wherein the aperture is an arcuate shaped slot that is configured to receive a post of the second member to define the limit of relative rotation between the first and second members.

12. The mounting assembly of claim 11, wherein the first member includes a second arcuate shaped slot located on the base on an opposing side of the opening relative to the first slot, the second slot being configured to receive a second post of the second member to limit the relative rotation between the first and second members.

13. The mounting assembly of claim 8, wherein the catch is a hook configured to engage an inner surface of the opening of the base.

14. The mounting assembly of claim 8, wherein the body and the catch of the second member are integrally formed together.

15. The mounting assembly of claim 8, wherein the first member also includes an aperture and the second member includes an opening, wherein the aperture of the first member and the opening of the second member receive a stud to define a limit of relative rotation between the first and second members.

16. A method for mounting a lighting fixture to an overhead structure comprising:
mounting a lower member to a frame of the lighting fixture;
mounting an upper member to a section of the overhead structure; and
operatively connecting the lower member to the upper member, the upper member having a base with an opening therein, the lower member having an catch that passes through the opening in the upper member and engages an edge of the base, such that the edge pivotally supports the catch.

17. The method mounting the lighting fixture of claim 16, further comprising tilting the lighting fixture to an angle relative to the overhead structure, wherein the lower member has a rotated position relative to the upper member.

18. The method mounting the lighting fixture of claim 17, wherein the angle of lighting fixture relative to the overhead structure is an acute angle.

19. The method mounting the lighting fixture of claim 17, further comprising fixing the lower member to the upper member in the rotated position to maintain the angle of the lighting fixture relative to the overhead structure.

20. The method mounting the lighting fixture of claim 19, wherein the upper and lower members are fixed through the use of a fastener.

21. The method mounting the lighting fixture of claim 16, wherein the mounting of and connecting the members is performed by a single person.
